(19) United States
(12) Patent Application Publication
(10) Pub. No.: US 2004/0052683 A1
(43) Pub. Date: Mar. 18, 2004

(54) Portable vehicle exhaust analyzer module

(75) Inventors: Thomas M. Fudali, McHenry, IL (US); Timothy Ledger, Elkhorn, WI (US)

Correspondence Address: MCDERMOTT, WILL & EMERY, 600 13th Street, N.W., Washington, DC, 20005-3096, US

(73) Assignee: SNAP-ON TECHNOLOGIES, INC., LINCOLNSHIRE, IL

(21) Appl. No.: 10/454,825

(22) Filed: Jun. 5, 2003

Related U.S. Application Data
(60) Provisional application No. 60/385,556, filed on Jun. 5, 2002.

(51) Int. Cl. G01N 27/00

(52) U.S. Cl. 422/58; 422/88; 422/98

(57) ABSTRACT

A vehicle exhaust analyzer module including a housing enclosure having symmetrical portions secured together, a support shelf supported within the housing enclosure, a gas inlet for directing gaseous vehicle exhaust into the housing enclosure, a sensor assembly positioned on the support shelf for receiving the gaseous vehicle exhaust and providing an analysis of the gaseous vehicle exhaust, circuitry for controlling the sensor assembly, and a signal output connector coupled to the control circuitry for outputting a signal representing an analysis result of the sensor assembly.

### CROSS-REFERENCE TO RELATED APPLICATION

The present application claims priority from co-pending provisional U.S. Patent Application Serial No. 60/385,556, filed Jun. 5, 2002, which is incorporated herein by reference in its entirety.

### FIELD OF THE DISCLOSURE

The present disclosure generally relates to motor vehicle maintenance equipment and methods and, more specifically, to a portable vehicle exhaust analyzer module.

### BACKGROUND OF THE DISCLOSURE

Due to government regulations, testing of vehicle exhaust emissions for compliance with minimum standards has become a necessary function for testing facilities and repair garages. Originally, only hydrocarbons and carbon monoxide had to be measured, but stricter standards have added oxygen and carbon dioxide, and still stricter regulations require oxides of nitrogen to be measured as well for compliance with statutory requirements. If a vehicle fails an emission test, it must be repaired. In the repair process, a mechanic must be able to tell whether the repairs have affected the content of the exhaust gas that was at an unacceptable level during the emission test. Therefore, there is a need for a vehicle sensor assembly that can be used by repair technicians to determine whether their repairs have remedied emission test failures.

Large platform engine analyzers were initially developed to measure gases emitted in vehicle exhaust. These platform engine analyzers were large devices that were transported by wheeling them around on a large cart. These large engine analyzers are typically utilized by government agencies to perform actual emission tests on vehicles, but their size and considerable expense make them difficult for smaller repair garages to own.

“Portable” exhaust sensor assemblys were subsequently developed to be used for repair purposes. One example of a hand-held vehicle exhaust analyzer in shown in U.S. Pat. No. 6,287,519 to Norman et al. The vehicle exhaust analyzer is of a size and weight to be held in a user's hands. The system includes a housing with an inlet receiving exhaust emitted from the vehicle. A sensor assembly is disposed in the housing, receives the exhaust emitted from the vehicle through the inlet, and determines the content of a plurality of different gases in the exhaust. A control system is disposed in the housing and is operatively coupled with the sensor assembly to regulate operations of the sensor assembly and to receive and interpret results of operations of the sensor assembly. A power supplying apparatus is disposed in the housing to deliver power throughout the system. The housing, and all components disposed in the housing have a combined weight of no greater than about five pounds.

The vehicle exhaust analyzer shown in U.S. Pat. No. 6,287,519 to Norman et al. uses a multiple-gas non-dispersive infrared (NDIR) sensor assembly that is shown in U.S. Pat. No. 5,811,812 to Williams et al. The sensor assembly includes a pump assembly, a infrared source, a sample tube, an optical block, a nitrous oxide (NOx) sensor, and an oxygen (O₂) sensor.

What is still desired is a new and improved vehicle exhaust analyzer module. Preferably, the module will include a simple, light-weight, compact and rugged design, which is of a size and weight to be picked up and carried easily by a user, while still performing the same functions of sampling and sensing gas content in vehicle exhaust as previous exhaust analyzers.

### SUMMARY OF THE DISCLOSURE

The present disclosure provides a vehicle exhaust analyzer module including a housing enclosure having symmetrical portions secured together, a support shelf supported within the housing enclosure, a gas inlet for directing gaseous vehicle exhaust into the housing enclosure, a sensor assembly positioned on the support shelf for receiving the gaseous vehicle exhaust and providing an analysis of the gaseous vehicle exhaust, circuitry for controlling the sensor assembly, and a signal output connector coupled to the control circuitry for outputting a signal representing an analysis result of the sensor assembly.

Among other benefits and features, the present disclosure provides a new and improved vehicle exhaust analyzer module that includes a simple, light-weight, compact and rugged design, which is of a size and weight to be picked up and carried easily by a user, while still performing the same functions of sampling and sensing gas content in vehicle exhaust as previous exhaust sensor analyzers.

According to one aspect of the present disclosure, the symmetrical portions of the housing enclosure form an internal wall supporting the support shelf. According to another aspect, the housing enclosure is made from plastic. According to an additional aspect, the housing enclosure includes a handle for lifting and carrying the module. According to a further aspect, the symmetrical portions of the housing enclosure are secured together with screws.

According to another aspect of the present disclosure, the module has a weight of not more than about eleven pounds. According to an additional aspect, the housing enclosure has dimensions of not more than about 14 inches long by about 9 inches tall by about 8 inches wide.

According to an additional aspect of the present disclosure, a battery is positioned within the housing enclosure and connected to the control circuitry. According to a further aspect, the battery is rechargeable. According to yet another aspect, a power supplying apparatus is positioned within the housing enclosure, and connected to the control circuitry, and connectable to a cigarette lighter receptacle of a vehicle under test or a wall outlet charger.

According to a further aspect of the present disclosure, the module includes a filter assembly for filtering gaseous vehicle exhaust prior to the gaseous vehicle exhaust entering the gas inlet of the housing enclosure. According to a still another aspect, a sensor is provided within the filter assembly and connected to the control circuitry, for sensing if the filter assembly is filled with water. According to yet an additional aspect, the control circuitry is programmed to stop operation of the sensor assembly upon receiving a signal from the sensor indicating that the filter assembly, which normally is self-draining, is filled with water.

According to another aspect of the present disclosure, the module includes a gas outlet for releasing gaseous vehicle exhaust from the housing enclosure, and a sensor positioned in the gas outlet and connected to the control circuitry, for sensing if an external line is connected to the gas outlet. According to an additional aspect, the control circuitry is programmed to stop operation of the sensor assembly upon receiving a signal from the sensor indicating that an external line is not connected to the gas outlet.

According to still another aspect of the present disclosure, the support shelf includes a base plate and end walls extending upwardly from opposing ends of the base plate, the housing enclosure includes open ends closed by the end walls of the support shelf, and the end walls of the support shelf are received in circumferential grooves of the open ends of the housing enclosure. According to a further aspect, all components of the module other than the housing enclosure and the battery are mounted on the support shelf. According to an additional aspect, the housing enclosure includes a bottom panel having drain holes for draining internally leaked water from the module.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is an end, side and top perspective view of an exemplary embodiment of an exhaust analyzer module constructed in accordance with the present disclosure;

FIG. 2 is an opposite end, side and top perspective view of the exhaust analyzer module of FIG. 1;

FIG. 3 is an end, opposite side and bottom perspective view of the exhaust analyzer module of FIG. 1;

FIG. 4 is an end, opposite side and top perspective view of the exhaust analyzer module of FIG. 1;

FIG. 5 is an exploded end, opposite side and top perspective view of the exhaust analyzer module of FIG. 1;

FIG. 6 is an end and bottom perspective view of one of two identical body portions of the exhaust analyzer module of FIG. 1, wherein the body portion is shown lying on a side thereof;

FIG. 7 is an end and top perspective view of the body portion of the exhaust analyzer module of FIG. 1, wherein the body portion is shown lying on a side thereof;

FIG. 8 is an end and top perspective view of the body portion of the exhaust analyzer module of FIG. 1;

FIG. 9 is an end and side perspective view of the body portion of the exhaust analyzer module of FIG. 1; and

FIG. 10 is an end, side and top perspective view of the exhaust analyzer module of FIG. 1 shown with connectors, a filter assembly and a sample exhaust gas hose.

### DETAILED DESCRIPTION OF THE DISCLOSURE

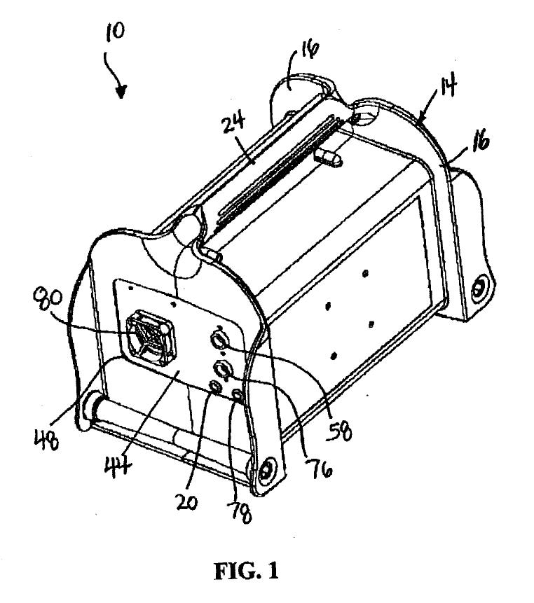

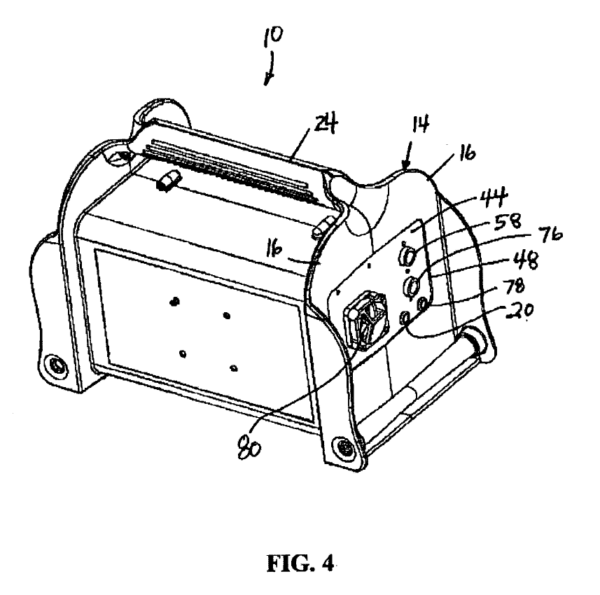

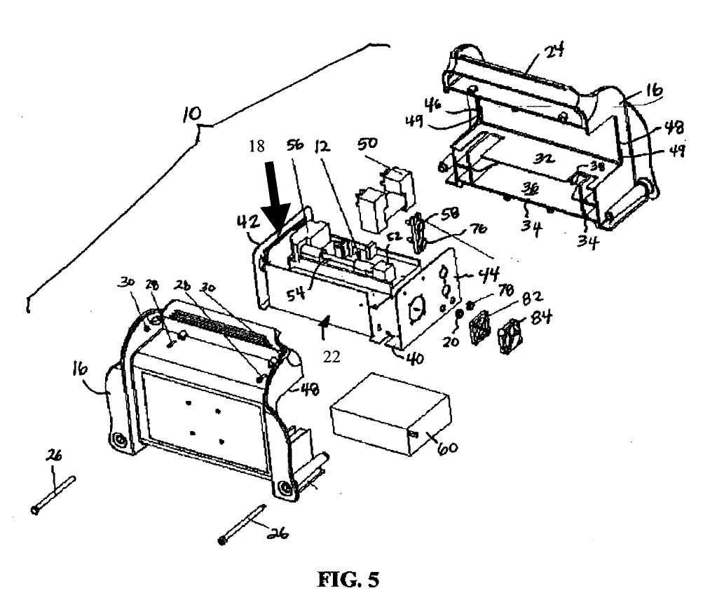

FIGS. 1 through 5 and FIG. 10 show an exemplary embodiment of a portable vehicle exhaust analyzer module 10 constructed in accordance with the present disclosure. In general, the exhaust analyzer module 10 is used for the measurement of vehicle exhaust gases including carbon monoxide, hydrocarbons, carbon dioxide, oxygen, and oxides of nitrogen. The module 10 accepts exhaust gas samples from a vehicle under test and contains a sensor assembly 12 (as shown in FIG. 5) that provides measurements of the contents of the gas sample to a remote computer (not shown), such as a pocket personal computer, laptop or desktop computer, or a specialty computer such as the MODiS™ modular diagnostic information system available from Snap-On Incorporated of Kenosha, Wis. Software including a vehicle exhaust diagnostic program is loaded on the remote computer for allowing a technician to utilize the measurements produced by the module 10 to determine the contents of the vehicle exhaust.

As shown best in FIG. 5, the module 10 includes a housing enclosure 14 having two symmetrical portions 16 secured together, a support shelf 18 supported within the housing enclosure 14, and an exhaust gas inlet 20 for directing gaseous vehicle exhaust into the module 10. The sensor assembly 12, which is positioned on the support shelf 18, receives the gaseous vehicle exhaust and provides an analysis of the contents of the gaseous vehicle exhaust. Control circuitry is mounted on a controller PCB 22 for controlling the sensor assembly 12, and a signal output connector 66 is coupled to the control circuitry of the controller PCB 22 for outputting (to a remote computer) a signal representing an analysis result of the sensor assembly 12.

Among other benefits and features, the present disclosure provides a new and improved vehicle exhaust analyzer module 10 that includes a simple, light-weight, compact and rugged design, which is of a size and weight to be picked up and carried easily by a user, while still performing the same functions of sampling and sensing gas content in vehicle exhaust as previous exhaust sensor analyzers. The module 10 also includes provisions for mounting a handheld pocket personal computer, PDA or Palm type PDA, directly on to the side of the module 10 for easy, convenient access and storage.

The housing enclosure 14 is preferably injection molded from a plastic, in order to provide sufficient strength with minimal weight. The module 10 is preferably about 14 inches long by 9 inches high, and about 8 inches wide, and the module 10 weighs about 11 pounds, so that it can be easily picked up and carried by a user. The housing enclosure 14 includes a handle 24 for lifting and carrying the module 10. As shown best in FIG. 5, the symmetrical portions 16 of the housing enclosure 14 are secured together with various screws 26, 28, 30 according to one exemplary embodiment of the present disclosure.

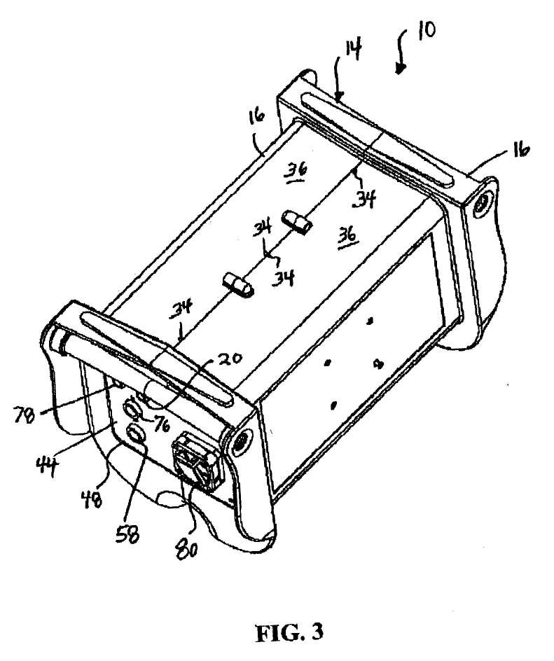

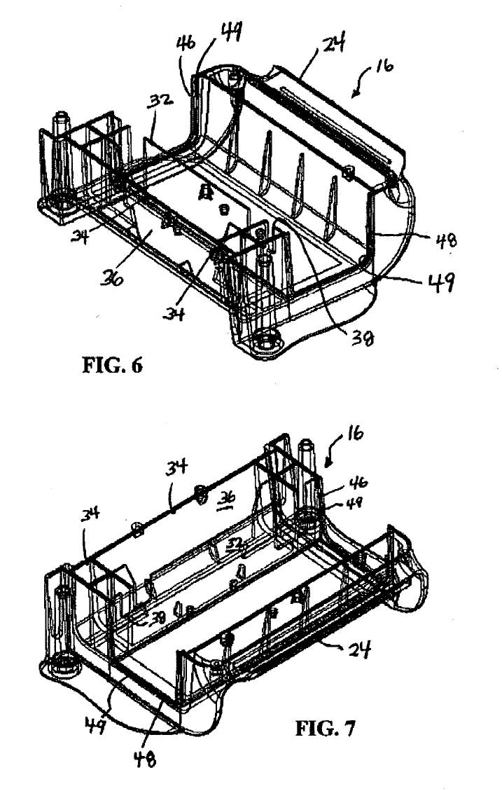

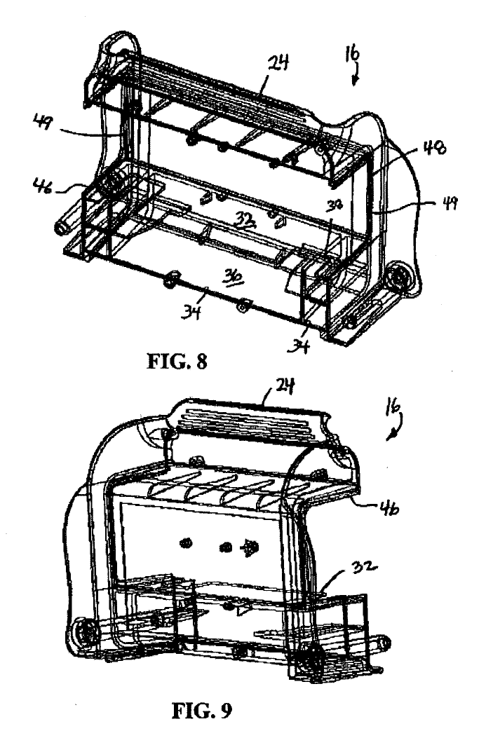

FIGS. 6 through 9 show one of the symmetrical portions 16 of the housing enclosure 14. FIG. 5 shows both of the symmetrical portions 16 of the housing enclosure. Each symmetrical portion 16 includes a ledge 32, which together form an internal wall supporting the support shelf 18. As shown in FIGS. 5 through 8, the symmetrical portions 16 of the housing enclosure 14 can also each include notches 34 in a bottom panel 36 which form drain holes in the assembled housing enclosure 14 as shown in FIG. 3. The drain holes 34 allow water to exit the module 10 upon an internal leak occurring within the module. The ledges 32 also include notches 38 which align with the notches 34 in the bottom panel 36 to aid drainage.

The support shelf 18 includes a base plate 40 and first and second end walls 42, 44 extending upwardly from opposing ends of the base plate 40. Open ends 46, 48 of the assembled housing enclosure 14 are closed by the end walls 42, 44 of the support shelf 18. The symmetrical portions 16 of the housing enclosure 14 each include circumferential grooves 49, as best shown in FIGS. 6 through 8, that receive edges of the end walls 42, 44 of the support shelf 18 upon the housing enclosure 14 being assembled around the support shelf 42, 44.

The sensor assembly 12 is shown in FIG. 5 and may preferably be a gas bench such as manufactured by Andros, Incorporated of Berkeley, Calif., and includes pump assembly 50, infrared source 52, sample tube 54, optical block 56, nitrous oxide sensor (not viewable), and oxygen sensor (not viewable). The control circuitry of the controller PCB 22 is connected to and controls the sensor assembly 12. During operation, exhaust is received into the sensor assembly 12 and delivered into the sample tube 54 by the pump assembly 50. While the exhaust is in the sample tube 54, the infrared source 52 generates infrared light which travels through the exhaust in the sample tube 54, and is reflected into the optical block 56. The content of various gases (such as carbon monoxide, carbon dioxide, and hydrocarbons) can be determined by the response of different wavelengths of infrared light as they pass through the exhaust, as is known in the art. Exhaust then passes into the nitrous oxide sensor and the oxygen sensor, which are chemical sensors operable to determine the content of the respective gases in the exhaust. In this way, the content of five gases (as required in many government emissions programs) in exhaust emitted from a vehicle is determined. Exhaust then exits the sensor assembly 12 and is eventually released from the module 10 through an exhaust gas outlet 58.

Operation of a similar sensor assembly is described in greater detail in U.S. Pat. No. 5,811,812 to Williams et al., which is incorporated herein by reference. U.S. Pat. No. 5,811,812 to Williams et al. is assigned to Andros, Incorporated of Berkeley, Calif., and shows a multiple-gas non-dispersive infrared (NDIR) sensor assembly.

The sensor assembly 12 has a weight such that the weight of the entire analyzer module 10 does not exceed about eleven pounds. The sensor assembly 12 preferably operates at ambient temperature, so that the housing enclosure 14 of the analyzer module 10 can be composed of a light-weight plastic material. The sensor assembly 12 and the pump assembly 50 are also designed to draw a small amount of power (preferably about 10 watts), so as not to require a large power supply which would destroy the portability of the analyzer module 10. The sensor assembly 12 preferably has a sample rate of about seven liters per minute.

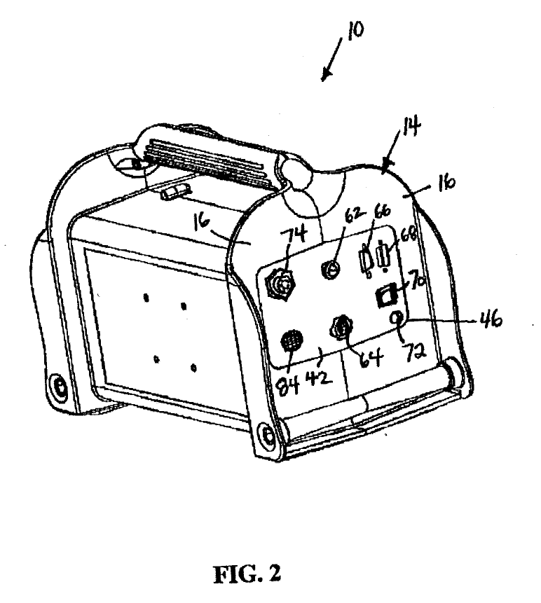

A battery 60 is positioned within the housing enclosure and connected to the control circuitry of the controller PCB 22. Preferably, the battery 60 is rechargeable and, as shown best in FIG. 2, the module 10 includes a power inlet plug 64 for recharging the battery. The module 10 also includes a power outlet plug 62 so that the battery 60 can be used to power a remote computer used with the module 10. Alternatively, power can be provided to the analyzer module 10 through the power inlet plug 64 by either cigarette lighter receptacle in vehicle being tested, or by a standard wall outlet. 12-volt DC power is routed through the inlet power plug to analyzer module 10, which also results in the battery 60 being charged through the controller PCB 22.

The battery 60 is positioned within the housing enclosure 14 on the bottom panels 36 of the housing enclosure 14 below the ledges 32 supporting the support shelf 18. All components of the module 10 other than the housing enclosure 14 and the battery 60 are mounted on the support shelf 18.

As shown best in FIG. 2, the module 10 includes all electrical/data connectors mounted on the first end wall 42 of the support shelf 18. The connectors includes the power inlet plug 64 and the power outlet plug 62, and the signal output connector. The signal output connector comprises two DB9S connectors 66, 68, and communication between the sensor assembly 12 and the external PC is in RS-232 format. A USB port 70 is also mounted in the end wall 42 and connected to the controller PCB 22. Although not shown, the module 10 includes a clip attachable to a screw hole 72 in the end wall 42 for supporting an external wire connected to the USB port 70. A connector 74 for receiving tachometer and oil temperature readings from the vehicle under test is secured to the end wall 42 and connected to the controller PCB 22.

As shown best in FIG. 1, the module 10 includes all fluid connectors mounted on the second end wall 44 of the support shelf 18. The fluid connectors includes the exhaust gas outlet 58, a calibrating gas inlet 76, the exhaust gas inlet 20 and a filtered fluid inlet 78.

The module 10 includes a fan 80 for drawing air through the housing enclosure 34. The fan 80 is connected to the control circuitry of the controller PCB 22, and the control circuitry includes a thermometer and is programmed to operate the fan 80 so that a temperature within the housing enclosure 34 is regulated. In addition, in conjunction with the controller PCB 22 and the fan 80, the internal battery 60 charge rate is regulated from a high rate to low, based on temperature, battery voltage and current by the controller PCB 22. The fan 80 is mounted on the second end wall 44 of the support shelf 18 (as shown in FIG. 5, the fan 80 also includes a filter 82), and an air vent 84 is provided in the first end wall 42 to allow air to be drawn into the module 10 by the fan 80.

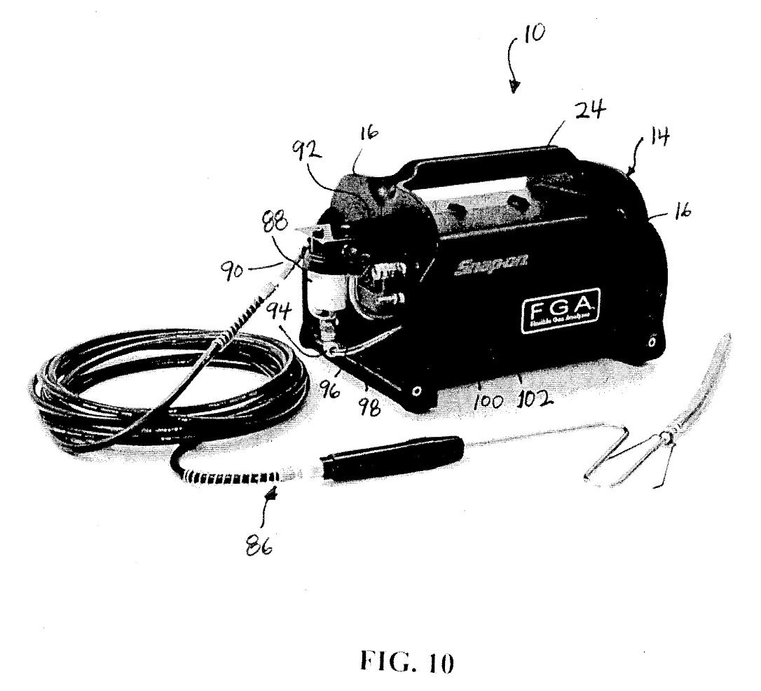

As shown best in FIG. 10, the module 10 further includes a sample hose 86 for coupling a tailpipe of a vehicle under test to the module 10, and a filter assembly 88 for filtering gaseous vehicle exhaust prior to the gaseous vehicle exhaust entering the module. The filter assembly 88 contains a hydrophilic filter operating to remove both dirt and moisture from the exhaust, and includes an inlet fitting nipple 90, an outlet fitting nipple 92, and a drain fitting nipple 94. Preferably the module 10 includes a sensor (not shown) within the filter assembly 88 and connected to the control circuitry, for sensing if the filter assembly 88 becomes filled with water. The control circuitry is programmed to stop operation of the sensor assembly 12 upon receiving a signal from the sensor indicating that the filter assembly 88 is filled with water.

A hose 96 connects the outlet fitting nipple 92 of the filter assembly to the exhaust gas inlet 20, and a hose 98 connects the drain fitting nipple 94 to the filtered fluid inlet 78. A nipple 100 is mounted in the calibrating gas inlet 76. A connector 102 is fitted in the exhaust gas outlet 58 and a sensor (not shown) is positioned in the connector 102 and connected to the control circuitry, for sensing if an external line is connected to the gas outlet 58. The control circuitry is programmed to stop operation of the sensor assembly 12 upon receiving a signal from the sensor indicating that an external line is not connected to the gas outlet (to ensure that the vehicle exhaust is properly disposed).

In operation, a user manually couples a distal end of the sample hose/probe 86 to a tailpipe of vehicle. Exhaust from tail pipe travels through sample hose/probe 86 and the filter assembly 88. The filter assembly 88 operates to filter dirt and condensation from the exhaust. The filtered exhaust then travels into the sensor assembly 12 though the exhaust gas inlet 20, where the content of carbon monoxide, carbon dioxide and hydrocarbons is determined. The pump 50 of the sensor assembly 12 then advances the exhaust through the nitric oxide sensor and the oxygen sensor of the sensor assembly. Exhaust then exits the analyzer module 10 through the exhaust gas outlet 58.

When an external PC is coupled to the analyzer module 10 via DB9S connectors, the sensor assembly 12 communicates directly with the external PC. Signal conditioning, formatting, and other software operations are performed by the external PC, so that data from sensor assembly can be interpreted and converted into useable values for vehicle diagnostics. Because of the vast memory available for storing and executing software, and potentially superior display capabilities, it may be desirable to utilize an external PC to analyze and/or display real-time parameters sensed by sensor assembly 12.

Thus, the present disclosure provides a new and improved vehicle exhaust analyzer module 10. The exemplary embodiment described in this specification has been presented by way of illustration rather than limitation, and various modifications, combinations and substitutions may be effected by those skilled in the art without departure either in spirit or scope from this disclosure in its broader aspects and as set forth in the appended claims. The vehicle exhaust analyzer module 10 disclosed herein, and all elements thereof, are contained within the scope of at least one of the following claims. No elements of the presently disclosed vehicle exhaust analyzer module 10 are meant to be disclaimed.

What is claimed is:

1. A vehicle exhaust analyzer module comprising:
a housing enclosure including symmetrical portions secured together;
a support shelf supported within the housing enclosure;
a gas inlet for directing gaseous vehicle exhaust into the housing enclosure;
a sensor assembly positioned on the support shelf for receiving the gaseous vehicle exhaust and providing an analysis of the gaseous vehicle exhaust;
circuitry for controlling the sensor assembly; and
a signal output connector coupled to the control circuitry for outputting a signal representing an analysis result of the sensor assembly.

2. A module according to claim 1, wherein the symmetrical portions of the housing enclosure form an internal wall supporting the support shelf.

3. A module according to claim 1, wherein the housing enclosure is made from plastic.

4. A module according to claim 1, wherein the housing enclosure includes a handle for lifting and carrying the module.

5. A module according to claim 1, wherein the symmetrical portions of the housing enclosure are secured together with screws.

6. A module according to claim 1, having a weight of not more than about eleven pounds.

7. A module according to claim 1, having dimensions of not more than about 14 inches long by about 9 inches tall by about 8 inches wide.

8. A module according to claim 1, wherein the sensor assembly has a sample rate of about seven liters per minute.

9. A module according to claim 1, wherein the sensor assembly operates at ambient temperature.

10. A module according to claim 1, further comprising a fan for drawing air through the housing enclosure.

11. A module according to claim 10, wherein the fan is connected to the control circuitry, and the control circuitry includes a thermometer and is programmed to operate the fan so that a temperature within the housing enclosure is regulated.

12. A module according to claim 1, further comprising a battery positioned within the housing enclosure and connected to the control circuitry.

13. A module according to claim 12, wherein the battery is rechargeable.

14. A module according to claim 1, further comprising a power supplying apparatus positioned within the housing enclosure, connected to the control circuitry, and connectable to a cigarette lighter receptacle of a vehicle under test and a wall outlet.

15. A module according to claim 1, further comprising a sample hose for coupling a tailpipe of a vehicle under test to the inlet of the housing.

16. A module according to claim 1, further comprising a filter assembly for filtering gaseous vehicle exhaust prior to the gaseous vehicle exhaust entering the gas inlet of the housing enclosure.

17. A module according to claim 16, further comprising a sensor within the filter assembly and connected to the control circuitry, for sensing if the filter assembly becomes filled with water.

18. A module according to claim 17, wherein the control circuitry is programmed to stop operation of the sensor assembly upon receiving a signal from the sensor indicating that the filter assembly is filled with water.

19. A module according to claim 1, further comprising a gas outlet for releasing gaseous vehicle exhaust from the housing enclosure and wherein a sensor is positioned in the gas outlet and connected to the control circuitry, for sensing if an external line is connected to the gas outlet.

20. A module according to claim 19, wherein the control circuitry is programmed to stop operation of the sensor assembly upon receiving a signal from the sensor indicating that an external line is not connected to the gas outlet.

21. A module according to claim 1, wherein the sensor assembly measures carbon monoxide, hydrocarbons, carbon dioxide, oxygen, and oxides of nitrogen.

22. A module according to claim 1, wherein the sensor assembly includes:
a source of infrared radiation;
a sample cell for containing an analyte gas, the sample cell being interposed in a path of infrared radiation emanating from the source of infrared radiation; and
an infrared radiation detector positioned in the path of infrared radiation after passing through the sample cell for providing an indication of the absorption of infrared radiation by the analyte gas.

23. A module according to claim 1, wherein the support shelf supported within the housing enclosure comprises a base plate and end walls extending upwardly from opposing ends of the base plate.

24. A module according to claim 23, wherein the housing enclosure includes open ends closed by the end walls of the support shelf.

25. A module according to claim 24, wherein the end walls of the support shelf are received in circumferential grooves of the open ends of the housing enclosure.

26. A module according to claim 1, wherein the housing enclosure includes a bottom panel having drain holes.

27. A module according to claim 1, further including a battery positioned within the housing enclosure on a bottom panel of the housing enclosure, wherein the housing enclosure includes an the internal wall supporting the support shelf and all components of the module other than the housing enclosure and the battery are mounted on the support shelf.

28. A module according to claim 1, wherein the support shelf supported within the housing enclosure comprises a base plate and end walls extending upwardly from opposing ends of the base plate, and wherein the a signal output connector is mounted on a first of the end walls and the module includes a clip attachable to the first end wall for supporting an external wire connected to the signal output connector.

29. A system including a module according to claim 1, and further including a remote computer connected to the signal output connector of the module.

30. A system according to claim 29, further including a vehicle exhaust diagnostic program loaded on the remote computer.
